(19) United States
(12) Patent Application Publication
(10) Pub. No.: US 2009/0089772 A1
(43) Pub. Date: Apr. 2, 2009

(54) ARRANGEMENT FOR SCHEDULING JOBS WITH RULES AND EVENTS

(75) Inventors: Arcangelo Di Balsamo, Aprilia (LT) (IT); Pietro Iannucci, Rome (IT); Franco Mossotto, Roma (IT); Francesca Liliana Pasceri, Rome (IT)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 12/190,968

(22) Filed: Aug. 13, 2008

(30) Foreign Application Priority Data
Sep. 28, 2007 (FR) FR8-2007-0134

(51) Int. Cl. G06F 9/46; G06F 17/30; G06F 9/44

(52) U.S. Cl. 717/168; 718/102; 707/100; 707/E17.044

(57) ABSTRACT

Arrangements for scheduling execution of jobs on target entities of a data processing system are disclosed. A plan can be stored that defines a flow of execution of a set of jobs. Each job can be executed on a selected target entity or a qualified entity such as a workstation with the appropriate configuration according to the plan. A set of rules may be utilized to invoke one or more actions in response to a detection of an event. Each target entity can detect one or more events. The execution of each action on a corresponding action target entity can be triggered based on a detected event.

### CROSS-REFERENCE TO RELATED APPLICATIONS

This application claims priority to an application filed in France, application number FR8-2007-0134 entitled Method, System and Computer Program for Scheduling Execution of Jobs Driven by Events, filed on Sep. 28, 2007.

### BACKGROUND OF THE DISCLOSURE

The present disclosure relates to the field of data processing. More specifically, this disclosure relates to the scheduling of the execution of jobs in a data processing system in response to rules and events.

Workload schedulers (or simply schedulers) are known for controlling the execution of large data processing jobs or tasks across an enterprise type computing system. One such commercial scheduler is commercially available from International Business Machine. This scheduler is often referred to as the Tivoli workload scheduler (TWS). Processing jobs can consist of work units that can be executed by one or more computer systems, servers or workstations.

A scheduler can be utilized to control the downloading of configuration files to network devices in a network configuration management system. Some schedulers can be located on a central scheduling server and can control the execution of the jobs on multiple workstations from this central location. The workstation for each job may be assigned to a job in a static configuration or can be assigned dynamically when a job requires execution. Thus, a job can be assigned to an available workstation having the required characteristics. Such a configuration can allow for a scalable system that is highly reliable.

The submission of a job to workstation can be controlled according to a predefined workload plan or simply a plan. The plan can establish a flow of execution of the jobs based on temporal constraints (i.e., date and/or time). In addition, the execution of the jobs can also be conditioned on specific dependencies such as the completion of preceding jobs. However, traditional schedulers are ineffective in controlling the execution of jobs that are not part of the original plan and may not even be defined until the need for their contribution is needed. Thus, when a job to be executed arises and there is no definition or allocation for the job problems can arise in traditional systems. For example, the unplanned job may arise from an occurrence of a specific event or the presence of an affirmed condition.

Traditional systems gather information on specific events that trigger unplanned jobs on a centralized server. However, collecting information on events at a central location can require considerable overhead. Moreover, the large amount of information regarding events that needs to be transmitted from workstations to the central server in traditional systems creates a significant amount of network traffic and processing overhead. Present scheduling systems are less than perfect.

### BRIEF SUMMARY

Arrangements described herein can be utilized to support scheduling of planned jobs and to integrate unplanned jobs into the scheduling plan according to rules and in response to events. In some embodiments a method for scheduling execution of jobs on target entities (such as workstations) of a data processing system can be performed by a scheduling entity of the system such as a scheduling server. The method can provide a plan which can define a flow of execution for individual jobs in a set of jobs. The method can provide the option of submitting each job for execution on a selected target entity according to the plan. A set of rules may also be selectively distributed where each rule can define an action to be executed on an action target entity in response to the detection of an event on an event target entity.

In some embodiments the method can include detecting events that are defined by a set of rules for each event target entity. Each event target entity can be enabled to detect one or more events. The execution of each action on the corresponding action target entity can be triggered in response to the detection of one or more corresponding events. An action may trigger an undefined or unplanned job. In some embodiments each event target entity can be a workstation and each workstation can be enabled to detect events utilizing configuration parameters and one or more detection modules running on the workstation. Configuration parameters can be sent to or deployed to workstations based on system needs and such a deployment can keep the parameters updated at each workstation.

In addition, the deployment of the configuration parameters to a workstation can be foregone or prevented when the latest version or an acceptable version of the configuration parameters exist on, and are useable by the workstation. In some embodiments, indicators for each version of the configuration parameters stored by a workstation can be compared to the latest version of configuration parameters and when needed the workstation can be sent new/updated configuration parameters. In some embodiments, an event server can receive event information from each workstation and can submit an action that is related to the event for execution on a target action entity or a qualified workstation.

In some embodiments, the system can utilize rules to control the operations described. For example, data, instructions and parameters may only be updated when a workstation or a server does not have either the appropriate version or the latest version. In some embodiments, updates are only provided to workstations when the updates have an impact on the job or system operation. Aspects of the disclosure can be implemented with a computer program that can execute the above-described method and can be implemented with a hardware system with processors.

### BRIEF DESCRIPTION OF THE DRAWING

Aspects of the disclosure may become apparent upon reading the following detailed description and upon reference to the accompanying drawings where like references may indicate similar elements.

FIG. 1 is a block diagram of a data processing system;

FIG. 2 is a block diagram having functional blocks of a computer system;

FIG. 3 is a block diagram of software components that can be utilized to implement a scheduling system; and

FIGS. 4A-4B is a flow diagram disclosing a flow of scheduling jobs.

### DETAILED DESCRIPTION OF EMBODIMENTS

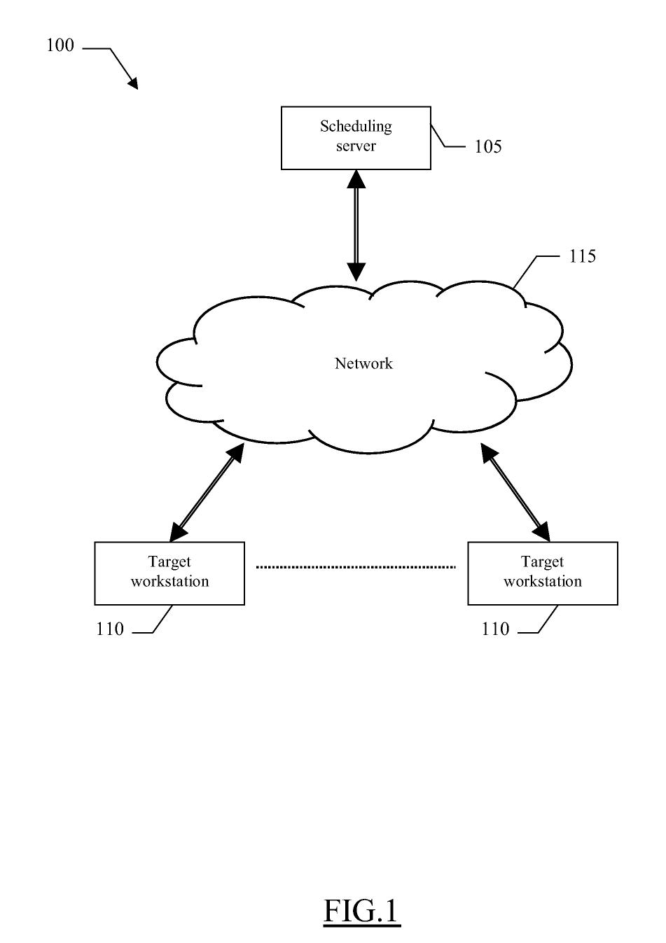

Referring to FIG. 1, a block diagram of a data processing system 100 that can schedule jobs and process unplanned jobs on a server-workstation computing system is illustrated. The system 100 can include a scheduling server (or simply server) 105, which can be utilized to control the execution of jobs. Jobs can consist of a batch process or a non-interactive process or application, such as payroll, accounting or a cost analysis program to name a few. Jobs can be executed under the control and supervision of the server 105 on a plurality of target workstations, illustrated by workstation 110. Server 105 and workstations 110 can communicate through a network 115, for example, a local area network (LAN) or possibly the Internet.

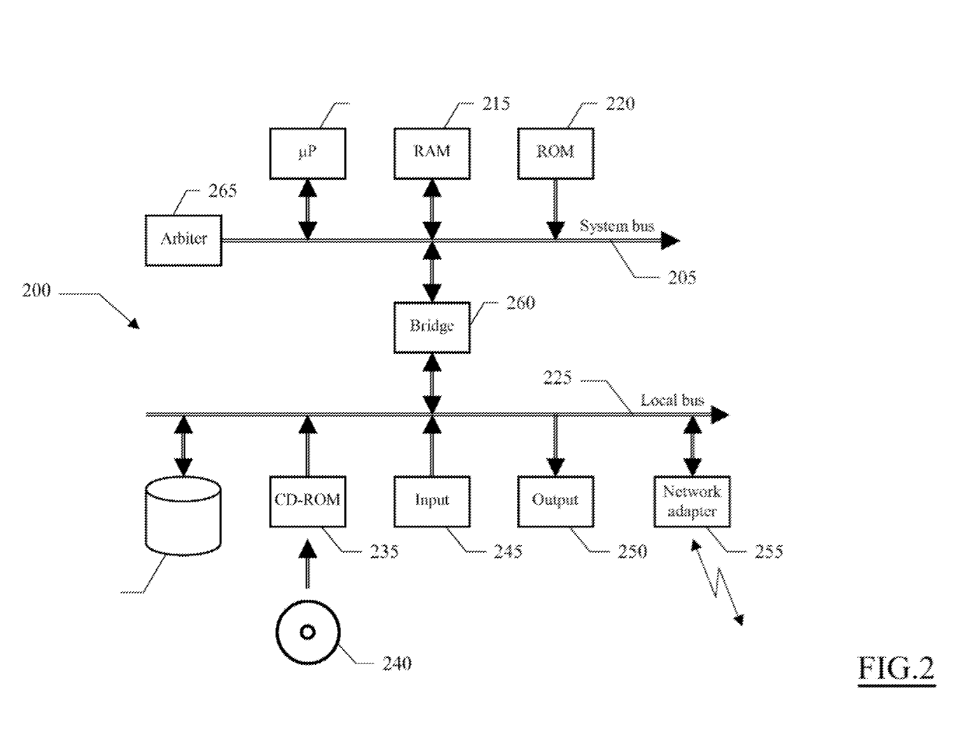

Referring to FIG. 2, a computer 200 suitable for executing the disclosed embodiments as a server or workstation is disclosed. Computer 200 can be formed by several components that are connected via a system bus 205. The system bus 205 can allow the system to be easily scaled. One or more processors 210 can be utilized to control operation of the computer 200. Random access memory (RAM) 215 can be utilized by the microprocessors 210 for working memory, and read only memory (ROM) 220 can be utilized to store basic code and to boot the computer 200 on start up. Several peripheral units may be clustered around a local bus 225 via interfaces.

The computer 200 can also include mass memory that consist of one or more hard disks 230 and a compact disk (CD) drive 235 for reading CDs 240. Moreover, the computer 200 can include input units 245, for example, a keyboard and a mouse, and output units 250 such as a monitor and/or a printer. An adapter 255 can be utilized to connect the computer 200 to the network (not shown). A bridge 260 can interface the system bus 205 with the local bus 225. Each microprocessor 210 and the bridge 260 can operate as a master agent requesting access to the system bus 205 and utilizing the system bus 205 to request and receive information. Arbiter 265 can manage and grant access to the system bus 205.

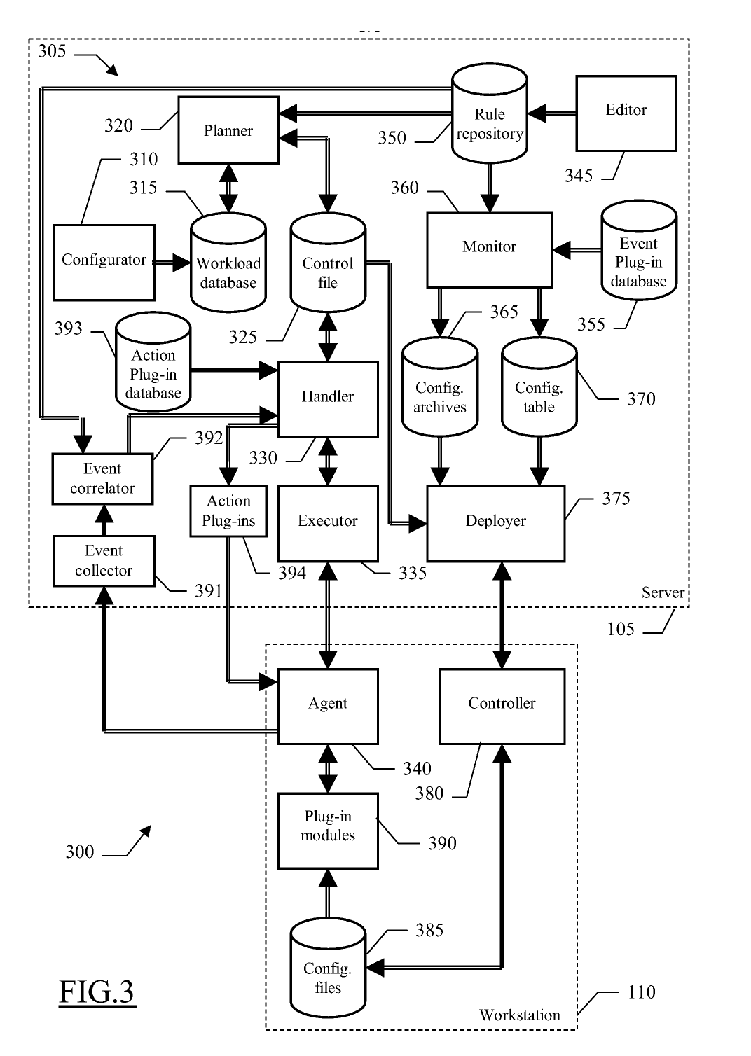

Referring to FIG. 3, software programs, components and/or modules 300 that can be utilized to schedule jobs and execute actions based on one or more detected events are disclosed. In some embodiments, information including software instructions, software programs and data can be utilized by modules 300 to implement the disclosed arrangements. Information and the modules 300 can be stored on the hard disk of a computer system and can be loaded (at least partially) into the working memory of each processor when the modules are being executed. Many programs can be run simultaneously on one or more processors with the help of an operating system and possibly other application programs (not shown). The programs can be installed onto the hard disk, for example, from CD-ROM and read from the CD-ROM when needed by a processor. In some embodiments, the server 105 can run a work scheduler such as scheduler 305. Scheduler 305 could be the Tivoli work scheduler (TWS) as described in the background section.

The scheduler 305 can include a configurator 310. The configurator 310 could be a composer such as the “composer” that is part of the TWS. The configurator 310 may be utilized to maintain a workload database 315 that is written in a suitable control language, for example, XML-based language. The workload database 315 may contain definitions of the workstations such as workstation 110 that are available to the scheduler 305. For example, workstation definitions may include information related to accessing descriptions, such as a name of a workstation an address, etc., together with the workstation's physical/logical characteristics such as processing power, memory size, operating system, loaded applications etc.

The workload database 315 can also include a descriptor file for each job. The descriptor can specify the programs to be invoked, along with their arguments and environmental variables that can be utilized to define the job. Moreover, the job descriptor can indicate minimum or preferred workstation requirements such that a job can be assigned to a workstations that is capable of executing the job. A workstation for executing the job can be selected, either statically or dynamically based on current or newly determined characteristics. New characteristics can emerge when new or unplanned jobs emerge and the system needs to process an unplanned job.

The job descriptor may include temporal constraints for the execution of the job. One temporal constraint can be a run-cycle. The run-cycle can define when a job is run. A run cycle can specify that a job is run every day, every week or every month, when the appropriate resources become available, specify a latest time that the job should be started and/or define a maximum allowable duration. In some embodiments, the job descriptor can specify dependencies related to the job such as conditions that must or should be met before the job enters an execution stage. Other dependencies such as exemplary dependencies may define one or more sequence constraints or one or more enabling constraints.

A sequence constraint may dictate that another job be successfully completed before the subject job begins, while an enabling constraint may dictate that a user enter a response to a prompt prior to executing a job. Generally, the system can organize jobs into streams where each job stream can consist of an ordered sequence of logically related jobs. In some embodiments, such jobs can be operated as a single work unit as long as the predefined dependencies are satisfied. The term job as utilized herein can denote either a single job or a job stream.

The workload database 315 can store statistical information relating to previous executions of one or more jobs. The workload database can store data regarding job such as the duration of a particular job and such information can be utilized to estimate a job duration for a future execution of a like job. A planner 320 such as the “master domain manager” of the TWS product can be utilized to create and edit a job execution plan. The planner 320 can allow a user to create job definitions and such definitions can be stored in control file 325. The planer 320 can operate the same as or similar to the “symphony” portion of the TWP. The plan can specify the flow of the execution of jobs in a specific production period, typically one day, together with the definition of the required workstations. In some embodiments a new plan can be created automatically before every production period.

Thus, planner 320 may process the information available in the workload database 315 so as to select jobs for execution and prioritize or arrange the execution sequence according to the job's expected duration, temporal constraints, and dependencies. Planner 320 can then create a useable plan by adding jobs to be executed for the next execution/production period and by removing processed jobs from the list of jobs to be executed. If execution of a job commenced during a previous production period and the job was not successfully completed during this period, is still in a queue, running or waiting to be run, such a job can be maintained in the execution plan for the next production period.

Handler 330 can perform operations similar to the “batchman” portion of the “TWS.” The handler 330 can start the plan at the beginning of every production period. The handler 330 can then submit each job for execution to a target entity such as a workstation, or a server as such a resource becomes available. Thus, handler 330 can select a target entity from among the available resources where the target entity can have the desired capacity/capability to process the job. In some embodiments, jobs can be evenly distributed over the target resources by a load balancer (not shown).

Execution of jobs can be managed by executor 335. Executor 335 can function similar to the “jobman” portion of the TWS product. The executor 335 can interface with an execution agent 340. Execution agent 340 be locates on multiple workstations can run simultaneously on one or more workstations. As stated above, although only one workstation is illustrated, workstation 110 is intended to illustrate a plurality of workstations.

Execution agent 340 can manage the execution of a job in response to a corresponding command received from executor 335, and can return information such as the results of an executed job and any run data or feedback relating to the system and to the execution of one or more jobs. For example, agent 340 can return run data and feedback regarding whether the job has been completed, completed successfully, the duration of the execution, weather acceptable results have been achieved etc. The feedback and run data can be passed by the executor 335 to the handler 330 and the handler 330 can organize such information in control file 325. Thus, control file 325 can be utilized as a repository for data and source of “real-time” data that can indicate a current state of jobs in the plan and statuses of servers and workstations. At the end of the production period, planner 320 can access the control file 325 and update statistical information in the workload database 315 based on jobs submitted for execution.

It can be appreciated that during the execution of one or more jobs the system might encounter a condition or an event that requires the system to take some action that is not in the original plan. The disclosed system can efficiently accommodate unplanned or unanticipated activities or actions that arise due to the occurrence of an event. For example scheduler 305 or configurator 310 can encounter an event. In some embodiments, scheduler 305 can be notified of an event and can facilitate the execution of an unplanned actions based on the detected event.

When an event is detected the scheduler 305 can select an action target entity based on available resources capabilities to process the unplanned effort created by the emergence of the event. More specifically, scheduler 305 can create and define new jobs (unplanned jobs) or actions in response to a detected event that creates a need for the unplanned effort such as execution of an action. In some embodiments, each workstation may have an event detection module that monitors and detects specific events or events of interest. Such events can include occurrences of a particular phenomenon on a workstation such as a processing error or a power outage and such a detection can trigger the scheduler 305 to locate and select an action target entity for addressing the unplanned effort.

The scheduler 305 can prompt the loading of instructions on the located action target entity and the action target entity can process the action. In some embodiments, the detection of events could invoke selective deployment of customized configuration files to the action target entity. As stated above scheduler 305 can schedule the execution of jobs, actions or action jobs. In some embodiments the scheduler 305 can control the execution of many different actions simultaneously, even when the need for execution of the actions is not known prior to the occurrence of the triggering event or the triggering series of events.

This adaptive control feature allows undefined jobs to enter into the plan based on what resources are available and such actions can be processed as qualified resources become available. Accordingly, the scheduler 305 can address an action by locating and selecting an action target entity that can provide the desired results. The action target entity could be the workstation that encounters the event or could be an entity that is unrelated to the affected workstation but has the appropriate infrastructure, capability and capacity.

The scheduler 305 can provide effective results in response to a detected event by addressing an action that corresponds to the detected event. It can be appreciated that such a spontaneous amendment to or deviation from the plan can be achieved by the scheduler 305 because the scheduler 305 mitigates the effects on workstations and servers due to the deviation from the plan. Thus, the increased overhead in traditional systems due to the occurrence of events can be reduced by the disclosed scheduler 305 because most workstations and servers in the system will not utilize a significant overhead and there will be no significant increase in network traffic due to an event and an unplanned action.

Editor 345 can be utilized to update and maintain one or more rules stored in the rule repository 350. The rule repository 350 can be secured by an authentication/authorization mechanism and such a mechanism can control updates to the rules and additions to the rules as they become available. Each rule in the repository 350 can define attributes of an action to be executed on a corresponding action target entity (i.e. workstation) when an event I detected. A number of different events may be detected by the disclosed system and such a detection can active one or more actions based on the rules. For example, an event may consist of detecting an error condition for a job, a shutdown of a workstation, a loss or power or the creation of or deletion of a file to name a few.

The action(s) can consist of the submission of a job for its execution. Accordingly, a rule can specify the commencement of a job, including a job that is not defined in the original plan. Some actions can be a plug-in or can be supported by a plug-ins, a notification etc. For example, an action could be an e-mail notification sent to a user, based on a power outage event. In some embodiments a command to turn-on a workstation, could be an action in response to a failed server at another location. The events may be detected and the actions may be executed on any computer or action target entity connected to the system. For example, the events relating to a change of status of a job can be detected by a server and/or a workstation and other entities can accept and process the job. Moreover, the actions can be implemented as the submissions of statically or dynamically defined jobs that can be executed on workstations, according to one or more characteristics.

The plug-in modules, or simply plug-ins can be implemented as an action where the plug in is called or loaded and executed in response to one or more detected events. One example, of an event driven action plug-in can be a file scanner and another example of an action plug-in can be an e-mail program. Thus, a file can be scanned in response to a detected event or an e-mail can be sent in response to a detected event. The repository 350 can store events to be detected and the planner 320 can access the repository 350 and can be utilized to add events and information related to events to the repository 350. Such information can be utilized to detect events and to call and execute the appropriate action or actions corresponding to the detected event(s) as defined by the control file 325. If an event is detected, the plug-in database 355 can associate the detected event with a corresponding event plug-in action.

In some embodiments monitor 360 can detect changes to the rules stored in the repository 350 and can update the system or process if one or more rule changes to the rules are detected. In some embodiments, the monitor 360 can monitor the server 105 and workstations 110, can detect one or more occurrence of events, can locate applicable rules corresponding to event detection, can coordinate rules with the detected events and the action and can coordinate operation of the selected workstation or action target entity. Monitor 360 can create a configuration file for each event plug-in associated with the events utilizing the event plug-in database 355. Configuration parameters can be set utilizing the event plug-in, where the configuration parameters can be utilized to detect the desired event(s).

The configuration parameters for each workstation can be compressed and combined to create a single configuration parameter archive for each workstation. The monitor 360 can save the configuration archives into a corresponding repository such as repository 365. The monitor 360 can also perform error detection by calculating a cyclic redundancy code (CRC) for each configuration archive by applying a 16- or 32-bit polynomial to the CRC calculation. Monitor 360 can utilize the configuration table 370 to associate each workstation with a corresponding configuration archive and a corresponding CRC.

A deployer 375 can transmit each CRC to the corresponding workstation, as indicated by configuration table 370. Deployer 375 can retrieve the CRC and other information from the definitions of a workstation from control file 325. The information can be accepted by and utilized by controller 380. Controller 380 can access the configuration files 385 based on the detection of an event or based on the activation of an action plug-in 390 that is installed on the workstation 110. When the received CRC differs from the corresponding CRC in the configuration file 385, the controller 380 can download a new configuration archive from the server 105 through the deployer 375, and update the configuration file(s) 385. The configuration archives that are provided by the server 105 can be encrypted and secured to provide system confidentiality and integrity.

Plug-ins 390 can interface with agent 340 to exchange information with server 105. Agent 340 can notify event collector 391 of one more detected events. The notifications of the events provided by the workstation 110 can also be encrypted and secured to provide system confidentiality, security and integrity. The event collector 391 can pass event notifications based on detected events of a workstation to event correlator 392. Event correlator 392 can access the rule repository 350 to determine the actions to be executed in response to the detected events as applied to the corresponding workstation(s). For each action to be executed on a specific workstation, the event correlator 392 can pass specific information to the handler 330. In some embodiments, the handler 330 can access an action plug-in database 393 based on the information.

The action plug-in database 393 can associate each action with the corresponding action plug-in such that the plug-in can be executed. The handler 330 can then call or invoke one or more action plug-ins from action plug in database 394, where the selected plug-in is associated with the action to be executed. Each action plug-in stored in the plug in database 394 can control the features of the process or the execution of the corresponding action on the selected/applicable target entity. An action plug-in can interface with agent 340 running on each relevant target entity as shown with respect to workstation 110. An action plug-in may also include modules adapted to perform user notifications, for example generating and sending an e-mail based on a particular phenomena.

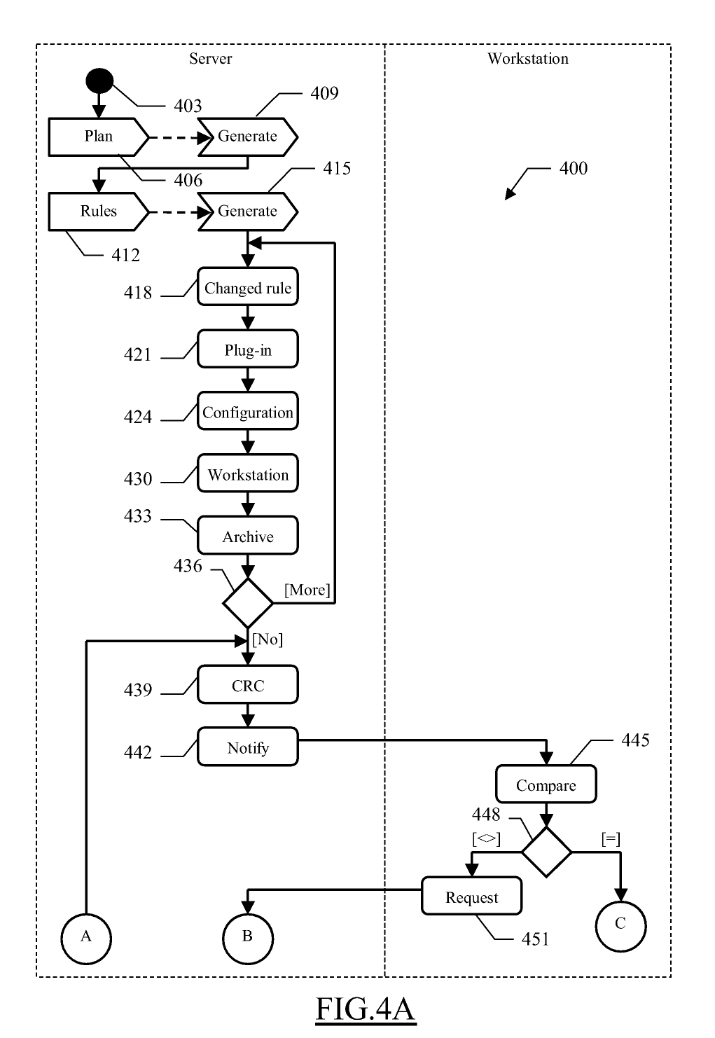

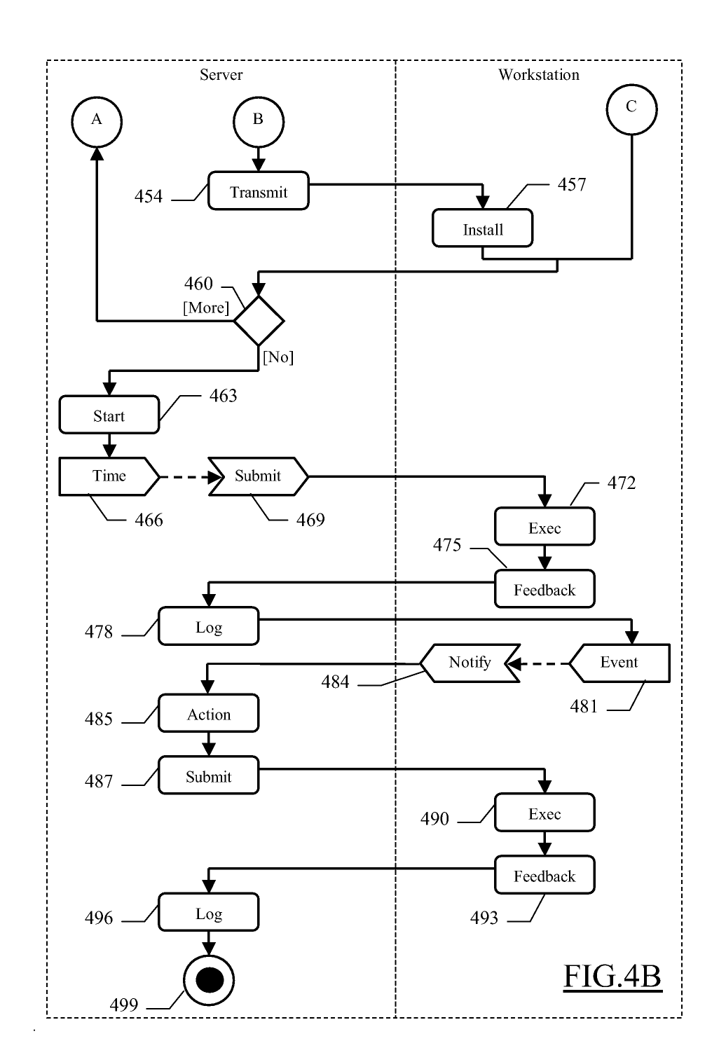

In reference to FIGS. 4A-4B, the flow of a scheduling process 400 for the execution of jobs is disclosed. As illustrated by block 403, the process can begin as a server function. As illustrated by block 406 a new plan can be created. As illustrated by block 409, a definition of the plan can be generated and stored into the control file. The plan can include a specification dictating a flow of execution of jobs and the definition of the workstations required for such an execution.

As illustrated by block 412, the monitor can detect changes in the rules by checking parameters stored in a corresponding repository. As illustrated by block 415, if a rule change is detected, the plan can be regenerated and replaced utilizing a control file. Such a process can add definitions of the workstations where event can be detected and corresponding actions can be executed.

As illustrated by blocks 418-436, a loop can be implemented for processing rules that have been changed. As part of the loop, every changed rule can be identified, starting with the first changed rule that is detected. As illustrated by block 421, the event plug-in associated with the most recently changed rule for an event can be extracted from the event plug-in database. As illustrated by block 424, an event plug-in can be invoked by passing an indication of the event to be detected to the configuration file, as illustrated by block 424. Accordingly, the configuration file of the event plug-in can be generated with proper setting so that the corresponding configuration parameters can enable the event plug-in to detect an occurrence of the desired event.

An occurrence of the event defined in the rules can be detected by the workstation, as illustrated by block 430. As illustrated by block 433, the obtained configuration file can be added to the configuration archive files of the workstation. As illustrated by block 436, a test can be conducted to determine is another rule has been changed. If another rule has been changes the process can return to block 418 and the process can repeat for detected rule changes.

If all rule changes have been processed, a further loop can be entered for processing new configuration archives. As illustrated by block 439, a “new” CRC can be calculated for the configuration archives. As illustrated by block 442, the new CRC can be transmitted to the corresponding workstation. In response thereto, the workstation can calculate the old CRC of the configuration files that is currently installed on the work station. The new CRC may then be compared with the old CRC, as illustrated in block 445. The flow of activity can branch as illustrated by block 448 according to the result of the comparison. If the new CRC differs from the old CRC, as illustrated by block 451 the workstation can archive the new configuration to the server.

Referring to FIG. 4B, and returning to the server, the required new configuration archive can be transmitted to the workstation, as illustrated by block 454 in FIG. 4B. Once the new configuration archive has been received by the workstation at block 457, the configuration files of the workstation can be extracted and installed onto the workstation. The method then may descend as illustrated by block 460 to the server. Block 460 can also be reached from block 448 when the new CRC determined to be equal to the old CRC (as illustrated at circle C). As illustrated by block 460, a test may be made to determine whether all the new configuration archives have been processed. If the new CRC is not equal to the old CRC, the method can return to block 439 to repeat the operations described above for a new configuration archive, as illustrated by circle A.

The plan can be started at the beginning of the production period as illustrated by block 463. When every job of the plan is executed according to its temporal constraints and dependencies, the method can pass from block 466 to block 469. As illustrated by block 460, the job can be submitted for execution on a selected workstation from the available workstations having the desired characteristics and the job can be executed on the selected workstation as illustrated by block 472. In some embodiments, the task can be executed on the same workstation or server, as illustrated by block 457. As illustrated by block 478, the workstation can return feedback information relating to the result of the execution of the job to the server and the feedback information can be entered into a control file.

In an asynchronous manner, and as illustrated by block 481, if a generic event workstation detects one of the events indicated in the configuration files of a corresponding event plug-in, the workstation can notify the server of the event as illustrated by block 484. As illustrated by block 485, actions to be executed in response to event detection can be determined together with the corresponding workstations according to the rules extracted from the rule repository. The event correlator can evaluate the rules where each rule can define the execution of an action in response to an event.

The event correlator may also evaluate relationships among rules. In some embodiments, the event correlator can define the execution of an action in response to the detection of different events. As illustrated by block 487, the server can submit the results of the execution of each action to the desired workstation. Accordingly, the handler can invoke the corresponding action plug-in from the action plug-in database. In some embodiments, the server can send a corresponding notification, possibly via e-mail to the user of the workstation.

In response to the results, the action can be executed on the workstation, as illustrated by block 490, via the execution agent or the corresponding action plug-in. The workstation can return feedback information relating to the result of the execution of the action to the server as illustrated in block 493. In reference to the swim-lane of the server, as illustrated by block 496, the feedback information can be entered into the control file. The process can end thereafter as illustrated by concentric white/black stop circle 499.

The disclosed arrangements can allow for many logical and/or physical modifications and alterations. More specifically, various omissions, substitutions, and changes in the form and details, as well as other embodiments, may be possible although the present disclosure has been described with a certain degree of particularity with reference to the embodiments. The disclosed embodiments could be practiced without the specific details described. For example, the numerical examples provided above are provided to create a more thorough understanding of possible arrangements. Conversely, well-known features may have been omitted or simplified in order not to obscure the description with unnecessary particulars. Specific elements and/or method steps described in connection with disclosed embodiments may be incorporated in other embodiment as a matter of general design choice.

The disclosed arrangements may lend themselves to be implemented with an equivalent method by using similar steps, removing some steps being non-essential, or adding further optional steps. The steps may be performed in whole or in part in a different order, concurrently or in an interleaved order.

The disclosed arrangements may be applied to any other workload schedulers or equivalent applications. In the preceding description, reference may have been made to non-interactive jobs however this is not intended to be a limitation. The disclosed arrangements may be utilized to schedule the execution of any kind of work units, for example, interactive tasks. Likewise, the disclosed arrangements can be defined and/or generated in a different way, for example, based on any additional or alternative temporal constraints or dependencies, even based on dynamic relationships among the workstations. Any other criteria may be used for selecting the workstations for the submission of the jobs, for example, according to statistic methods for distributing the execution of the jobs uniformly.

The disclosed arrangements can be implemented with any other type of rules or policies for defining actions to be executed in response to corresponding events. Likewise, the above-described events and actions are merely illustrative, and should not be interpreted in a limiting manner. For example, basic rules can be combined into complex rules with any logical operator, such as OR, AND, and the like, so as to define the execution of actions in response to any combination of events, even on different workstations. The rules may define the execution of complex actions consisting of multiple basic actions, even on complex entities, each entity consisting of multiple (basic) workstations, i.e., by aggregating more rules based on the same event. The events may consist of the outcome of other rules. Moreover, the actions may also be conditioned by temporal constraints and/or dependencies.

Similar considerations may apply if the notifications are sent to additional or different users. Such conditions can apply even if the notifications are sent via different communication methods such as a short message service (SMS) or other methods. In some embodiments, the actions may only consist of jobs, of notifications, or of any other predefined type of operations. The need of regenerating the plan for including the information relating to the rules may not be strictly necessary.

Similar consideration may apply if the configuration files and the configuration archives are replaced with equivalent structures. For example, simply consisting of commands for forcing the desired behavior of the event plug-ins; likewise, the configuration files may be deployed to the relevant workstations in any other way, such as by exploiting a software distribution infrastructure.

In some embodiments the configuration files can be distributed indiscriminately to all the workstations. The CRC utilized could take on many different forms, for example, a CRC-4. Also the CRC could be replaced by a simple checksum of the configuration archive, by a hash value, or more generally by any other digest value representing the configuration archive in a far shorter form. Nothing may prevent managing the selective deployment of the configuration archives directly on the server, for example, by maintaining information about the actual status of all the workstations centrally.

In some embodiments each event target or workstation can send notification of each event directly to a corresponding action workstations directly, without passing the notification through a server. This notification can occur for every detected event or notification can occur only when the action is executed on the same workstation where the event has been detected. In some embodiments, the deployment of the desired configuration files can be done on request without any monitoring of the rules. In some embodiments the configuration files can be regenerate and deployed for all the workstations in response to detection of a single rule change. Structuring the disclosed arrangements a different way, possibly adding modules or functions, utilizing similar multi-workstation communications and other changes are contemplated. For example, each function of each block described above could be sent to a different server. Likewise, the memory structures may be implemented in many different ways and may be replaced with similar or equivalent entities, where such entities may not necessarily consist of physical storage media.

The method can take any form suitable that can be utilized by or in connection with any data processing system, such as external or resident software, firmware, or microcode (either in object code or in source code, for example, to be compiled or interpreted). A possibility may be to provide the program on any computer-usable medium; the medium can be any element suitable to contain, store, communicate, propagate, or transfer the program. For example, the medium may be of the electronic, magnetic, optical, electromagnetic, infrared, or semiconductor type. Examples of such medium may be fixed disks (where the program can be pre-loaded), removable disks, tapes, cards, wires, fibers, wireless connections, networks, broadcast waves, and the like. Some embodiments can be implemented with a hardware structure (for example, circuits integrated onto a semiconductor material), or with a combination of software and hardware. A possibility may include being able to deploy the disclosed embodiments as a service that can be accessed through a network, such as the Internet.

The proposed method may be carried out on a system having a different architecture or including equivalent units, for example, based on a local network. Each computer may include similar elements, such as cache memories temporarily storing the programs, or parts thereof to reduce the accesses to the mass memory during execution. A possibility may be to replace the computer with any code execution entity (such as a PDA, a mobile phone, etc.), or with a combination thereof (such as a multi-tier server architecture, a grid computing infrastructure, and the like.)

Embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system, (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

1. A method comprising:
storing a plan, the plan defining a flow of execution of a set of jobs and defining entities to execute the set of jobs;
selecting a target entity to execute at least one job in the set of jobs;
submitting the at least one job in the set of jobs to the selected target entity and executing the at least one job in response to the plan;
storing at least one rule, the at least one rule defining a relationship between an event and at least one action, the at least one action to be executed in response to the detected event;
detecting an event during an execution of the plan; and
utilizing the at least one rule associated with the detected event to facilitate execution of the at least one action.

2. The method of claim 1 wherein the at least one of the action comprises submitting an unplanned job that is not present in the plan to an action target entity, the unplanned job to be executed on an action target entity.

3. The method of claim 1 further comprising running an event detection module on the target entity to detect an event on the target entity.

4. The method of claim 1 further comprising checking a version of configuration parameters loaded on the selected target entity and updating the configuration parameters if the configuration parameters are not current and forgoing updating of the configuration parameters if the configuration parameters are current.

5. The method of claim 4 wherein checking comprises transmitting a configuration parameter version indicator to the selected target entity and comparing the configuration parameter version indicator with a stored indicator from a previous configuration parameter version indicator.

6. The method of claim 1 wherein the execution of the action comprises identifying an action target entity based on rules associated with the event, and submitting the action for execution on the action target entity.

7. The method of claim 1 further comprising detecting a change in the rules that affect the target entity and providing a new set of rules to the target entity based on the detected change.

8. The method of claim 7 wherein detecting the change to the rules that affects the target entity is provided by an event detection module loaded on the target entity.

9. A computer program product comprising a computer readable storage medium including instructions that, when executed by a processor:
provide a plan defining a flow of execution of a set of jobs;
select a target entity to execute a job from the set of jobs;
execute the job utilizing the selected target entity according to the plan;
detect an event related to the execution of the job;
utilize a set of rules, each rule defining an action to be executed on an action target entity in response to the detection of the event; and
execute an action on a target entity in response to the detection of the corresponding event.

10. The computer program product of claim 9 wherein the instructions when executed by a processor comprise submitting an unplanned job that is not present in the plan to an action target entity based on the detection of an event.

11. The computer program product of claim 9 wherein the instructions when executed by a processor comprise an event detection module on the target entity and on a plurality of target entities.

12. The computer program product of claim 9 wherein the instructions when executed by a processor comprise a version of configuration parameters loaded on the selected target entity and updating the configuration parameters if the configuration parameters are not current and forgoing updating of the configuration parameters if the configuration parameters are current.

13. The computer program product of claim 9 wherein the instructions when executed by a processor comprise transmitting a configuration parameter version indicator to the selected target entity and comparing the configuration parameter version indicator with a stored indicator from a previous configuration parameter version indicator.

14. The computer program product of claim 9 wherein the instructions when executed by a processor comprise identifying an action target entity based on rules associated with the event and submitting the action for execution on the action target entity.

15. The computer program product of claim 9 wherein the instructions when executed by a processor comprise detecting a change in the rules that affect the target entity and providing a new set of rules to the target entity based on the detected change.

16. A scheduling system comprising:
a planner to provide a plan that defines a flow of execution for a job from a set of jobs;
a handler to submit the job to be executed on a target workstation in response to the plan;
an event detector to detect an event based on a set of configuration parameters;
an editor to maintain a set of rules, each rule defining an action to be executed in response to the detected event;
a monitor to monitor events defined in the rules; and
an executor to facilitate execution of the action in response to the detection of the event.

17. The scheduling system of claim 16 further comprising an executor to submit the job to be executed on the selected target entity according to the plan.

18. The scheduling system of claim 16 further comprising a rule database coupled to the editor, the rule database to store at least one rule, the at least one rule defining an action to be executed in response to the detection of the event.

19. The scheduling system of claim 16 further comprising an event monitor to trigger execution of the action in response to the detected event.

20. The scheduling system of claim 16 further comprising a processor to process an unplanned job that is undefined in the plan based on the detection of an event.
